(19) United States
(12) Patent Application Publication
(10) Pub. No.: US 2005/0273775 A1
(43) Pub. Date: Dec. 8, 2005

(54) Apparatus, system, and method for identifying semantic errors in assembly source code

(76) Inventors: Craig William Brookes, Currambine (AU); John Robert Dravnieks, Kardinya (AU); John Robert Ehrman, Sunnyvale, CA (US)

Correspondence Address: KUNZLER & ASSOCIATES, 8 EAST BROADWAY, SUITE 600, SALT LAKE CITY, UT, 84111, US

(21) Appl. No.: 10/862,560

(22) Filed: Jun. 7, 2004

(51) Int. Cl. G06F 9/44

(52) U.S. Cl. 717/141

(57) ABSTRACT

An apparatus, system, and method are provided for identifying semantic errors in assembly source code. The apparatus includes a symbol module, an identification module, a validation module, and a notification module. The symbol module searches assembly source code for a symbol definition. The identification module recognizes an attribute assigned to a symbol. The validation module validates the attribute of the symbol against operand rules for an instruction in the assembly source code. The notification module generates warnings in response to the symbol violating the operand rules for the instruction.

### BACKGROUND OF THE INVENTION

1. Field of the Invention

The invention relates to computer programming. Specifically, the invention relates to apparatus, systems, and methods for identifying semantic errors in assembly source code.

2. Description of the Related Art

Computer programming involves writing a set of instructions to perform a desired function in a human readable format and converting them to a format that a computer understands. The processor module of a computer understands and executes machine code, instructions consisting of 1s and 0s. Although it is possible for a human programmer to decipher meaning in these 1s and 0s, it is not efficient or intuitive to write software instructions in machine code. Instead, programming computers typically involves writing lines of code in a high-level computer language that the programmer can readily read and understand. Once this code has been written, a translation program, such as a compiler, converts the programmer-written code into machine instructions that the computer understands and executes.

The use of high-level languages is more efficient than writing machine code since high-level language instructions are easily read and understood by a programmer. The vast majority of software is written in a high-level language. Typically, writing high-level code does not require a detailed knowledge of a specific computer processor that the machine code will eventually execute on. The compiler insulates this detail from high-level language programmers. In fact, the high-level code is often compiled into multiple versions of machine code, each version specific to a different type of computer processor.

Compilers enable programmers to efficiently create machine code. Writing in a high-level programming language and then compiling to machine code decreases the amount of processor specific knowledge a programmer must have. Using a compiler effectively multiplies the number of lines of code written by a programmer, converting tens of lines of a high-level language into hundreds of machine instructions.

While compilers are very useful and enable great efficiency, there are drawbacks to their use. In some cases, the machine code generated by the complier is not as compact or efficient as it could be if a programmer had written the machine code directly. This inefficiency is typically regarded as acceptable due to the greater programming efficiency that the high-level language provides. However some speed sensitive operations may justify writing instructions directly in machine code to minimize execution time.

In these cases a programmer often justifiably uses assembly language. Assembly language source code (also referred to herein as assembly source code or assembly code) is very low-level and typically processor dependent. Assembly code does not easily convert for use on other processors. Each line of assembly code may be translated into one or more machine code instructions. The machine instructions that result from translating assembly code to machine code are also very controllable and predictable. The programming efficiency gains of a higher-level language are generally lost using assembly code, in exchange for greater control over the code size, access to system services, and improvements in the time required to execute the code.

FIG. 1A illustrates the format of a typical assembly language instruction statement. The statement includes an instruction 100 and one or more operands 102,104. The operands are the arguments for the instruction 100.

FIG. 1B illustrates an example of an assembly language instruction statement 105. This statement 105 may be part of an example process for monitoring an outside temperature by comparing the outside temperature with a threshold. The statement 105 loads the current outside temperature, stored in memory address fifteen of a computer memory device, into a processor register. An additional instruction (not illustrated) compares the outside temperature with the threshold stored in another register.

FIG. 1B illustrates the assembly instruction statement that loads the outside temperature into a register from memory. The load instruction 106 is designated by the letter “L”. The first operand 108 specifies a destination register to be loaded, in this example register three, and the second operand 110 specifies a memory address that stores the outside temperature, memory address fifteen. As a result of executing the machine code generated from this assembly language instruction statement 105, the processor retrieves the data in memory address fifteen and places the data in register three.

The example of a software process for monitoring the outside temperature is further developed herein in order to illustrate certain capabilities and limitations of conventional assembly code programming languages. After the statement 105 is written, the programmer needs to remember that the current outside temperature is available in register three. A more intuitive way to refer to register three is to give register three an car intuitive name or label. The name or label that helps the programmer remember what the register contains is referred to as a symbol.

FIG. 1C illustrates a symbol definition statement 111. The symbol definition statement 111 assigns a value 114 to a symbol 112. The symbol 112 is assigned a value 114 by an operator 116.

FIG. 1D illustrates an example symbol definition statement 111. In this statement 113, the symbol 118, OTEMPREG, is assigned a value 120 three by the EQU operator 122. Now, instead of remembering the register number that stores the outside temperature, the programmer remembers an intuitive symbol, OTEMPREG, that can be used in the remainder of the assembly code in place of the value three.

In FIG. 1D, an instruction statement 123 uses the newly defined symbol 118. The instruction “L” 106 loads the OTEMPREG register 118, register three, with the data in memory address fifteen 110. In comparing this instruction statement 123 with the statement 105 illustrated in FIG. 1B, one notices that the programmer no longer refers to the register by number, but rather refers to the register by the symbol 118.

The shorthand method of using symbols makes writing assembly source code easier. However, a programmer may use symbols incorrectly without any warning. Detecting erroneous use may be very difficult and involve careful manual review of the assembly code, the machine instructions generated from the assembly code, and test cases.

FIG. 1E illustrates a common error in using symbols. In this example, the programmer forgets what he or she intended the symbol to mean. A symbol 118, OTEMPREG, is defined to have the value 120 three, as in the prior example. A second symbol 136, ITEMPREG, is defined to have the value 140 four. This symbol 136 is used to refer to a register intended to hold the inside temperature.

As before, the outside temperature is stored in memory location fifteen. The inside temperature is stored in memory location sixteen. In the next instruction 142, the programmer now intends to load the outside temperature register 144 with value 146 in the inside temperature register. The proper instruction to accomplish this would be “L OTEPMPREG,16”, since the inside temperature is stored in memory location sixteen.

The instruction 142 as written: “L OTEMPREG,ITEMPREG” using the N 0 defined symbols contains a semantic error. If the symbol values were used in this instruction statement instead of the symbols themselves, the instruction statement 142 would read: “L 3,4”. This will load register three with memory location four, which is not the intended result. The programmer forgot that the second operand 146 of the “L” instruction 142 is a memory address, not a register.

The instruction statement 142 will execute successfully since it is valid to load register three with the value in memory address four, however, whatever is stored in memory address four is not the inside temperature and is not the data that the programmer intended. This leads to erroneous results that are hopefully detected by the programmer while he or she tests the code.

If the problem is detected during testing or program production use, the programmer must spend time debugging the code until he or she finds the improper use of the ITEMPREG symbol 146. However, the erroneous result may not be readily apparent, creating a future liability for the programmer.

The example described illustrates a limitation of assembly code. Higher-level languages generally have functionality called type checking that prevents these errors. However this functionality is not available in assembly language.

One embodiment of conventional assembly level programming languages allows for symbol definition, as was illustrated in FIGS. 1C and 1D. Using symbols 112 is convenient since the symbols allows the programmer to assign intuitive, logical names to operands 102,104. However, these conventional versions do not perform any kind of semantic checking to prevent the user from using symbols 112 incorrectly, as illustrated in the example above (FIG. 1E).

Other conventional assembly level programming languages provide limited semantic checking of symbols. However, these versions rely on predefined symbols that have fixed names and fixed values. The programmer is not able to define new symbols. These symbols may or may not have names that are intuitive to the user. Additionally, the fixed symbols have fixed values. The user is unable to change the value associated with a symbol. In addition, the fixed symbols can only be used as operands in certain instructions. Consequently the programmer is unable to create intuitive symbols that may be used with any operators.

From the foregoing discussion, it should be apparent that a need exists for an apparatus, system, and method that identifies semantic errors in assembly source code by providing flexible, user-defined symbols and validating proper use of the symbols in the assembly source code. Beneficially, such an apparatus, system, and method would reduce the number of errors in assembly source code and drastically reduce the amount of time spent debugging assembly source code.

### SUMMARY OF THE INVENTION

The various embodiments of the present invention have been developed in response to the present state of the art, and in particular, in response to the problems and needs in the art that have not yet been met for identifying semantic errors in assembly source code. Accordingly, the various embodiments have been developed to provide an apparatus, system, and method for identifying semantic errors in assembly source code that overcomes many or all of the above-discussed shortcomings in the art.

An apparatus according to one embodiment of the present invention includes a symbol module, an identification module, a validation module, a notification module, and optionally a translation module. The symbol module searches assembly source code for a symbol definition. The identification module recognizes an attribute assigned to the symbol, and the validation module validates the attribute of the symbol against operand rules for an instruction in the assembly source code. If the symbol is not a valid operand then the notification module generates warnings. The translation module translates validated assembly source code into machine code.

The programmer assigns an attribute to a symbol. The attribute may be predefined (chosen from a set of attributes known to the assembler) or programmer-defined. The programmer also assigns a value to the symbol. Preferably, the value assigned to the symbol is validated against the attribute. The attribute typically defines an acceptable range, type, size, or the like for the value.

In validating predefined attributes, the validation module uses default operand rules. Preferably the programmer is able to modify the default operand rules. The validation module validates programmer-defined attributes using programmer-defined operand rules.

The present invention also includes embodiments arranged as a system and machine-readable instructions that comprise substantially the same functionality as the components and steps described above in relation to the apparatus. Embodiments of the present invention provides a generic assembly source code semantic error detection solution that uses an attribute to ensure that a symbol is properly used as an operand for an instruction. The features and advantages of different embodiments will become more fully apparent from the following description and appended claims, or may be learned by the practice of embodiments of the invention as set forth hereinafter.

### BRIEF DESCRIPTION OF THE DRAWINGS

In order that the advantages of the different embodiments of the invention will be readily understood, a more particular description of the embodiments briefly described above will be rendered by reference to specific embodiments that are illustrated in the appended drawings. Understanding that these drawings depict only typical embodiments of the invention and are not therefore to be considered to be limiting of its scope, the embodiments will be described and explained with additional specificity and detail through the use of the accompanying drawings, in which:

FIG. 1A is a diagram representing an example of the structure of a conventional assembly instruction statement;

FIG. 1B is a diagram representing an example of a conventional assembly instruction statement;

FIG. 1C is a diagram representing an example of the structure of a conventional symbol definition statement;

FIG. 1D is a diagram representing an example of conventional assembly source code using one symbol;

FIG. 1E is a diagram representing an example of conventional assembly source code using two symbols;

FIG. 2 is a schematic block diagram of one embodiment of a system for identifying semantic errors in assembly source code;

FIG. 3A is a schematic block diagram illustrating the components of assembly source code;

FIG. 3B is a text statement illustrating the structure of a symbol definition statement;

FIG. 3C is a chart illustrating an example set of predefined attributes;

FIG. 4 is a schematic block diagram illustrating one embodiment of an apparatus for identifying semantic errors in assembly source;

FIG. 5 is a schematic block diagram illustrating one embodiment of a method for identifying semantic errors in assembly source code;

FIG. 6 is an example of the structure of an operand rules table;

FIG. 7A is an example of assembly source code using a predefined attribute;

FIG. 7B is an example of an operand rules table; and

FIG. 8 is a schematic block diagram illustrating another embodiment of a method for identifying semantic errors in assembly source code.

### DETAILED DESCRIPTION OF THE INVENTION

It will be readily understood that the components of embodiments of the present invention, as generally described and illustrated in the Figures herein, may be arranged and designed in a wide variety of different configurations. Thus, the following more detailed description of the embodiments of the apparatus, system, and method of the present invention, as presented in the Figures, is not intended to limit the scope of the invention, as claimed, but is merely representative of selected embodiments of the invention.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, function, or other construct. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily all referring to the same embodiment.

Furthermore, the described features, structures, or characteristics may be combined in any suitable manner in one or more embodiments. In the following description, numerous specific details are provided, such as examples of programming, software modules, user selections, user interfaces, network transactions, database queries, database structures, hardware modules, hardware circuits, hardware chips, etc., to provide a thorough understanding of embodiments of the invention. One skilled in the relevant art will recognize, however, that the embodiments of the invention can be practiced without one or more of the specific details, or with other methods, components, materials, etc. In other instances, well-known structures, materials, or operations are not shown or described in detail to avoid obscuring aspects of the various embodiments.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

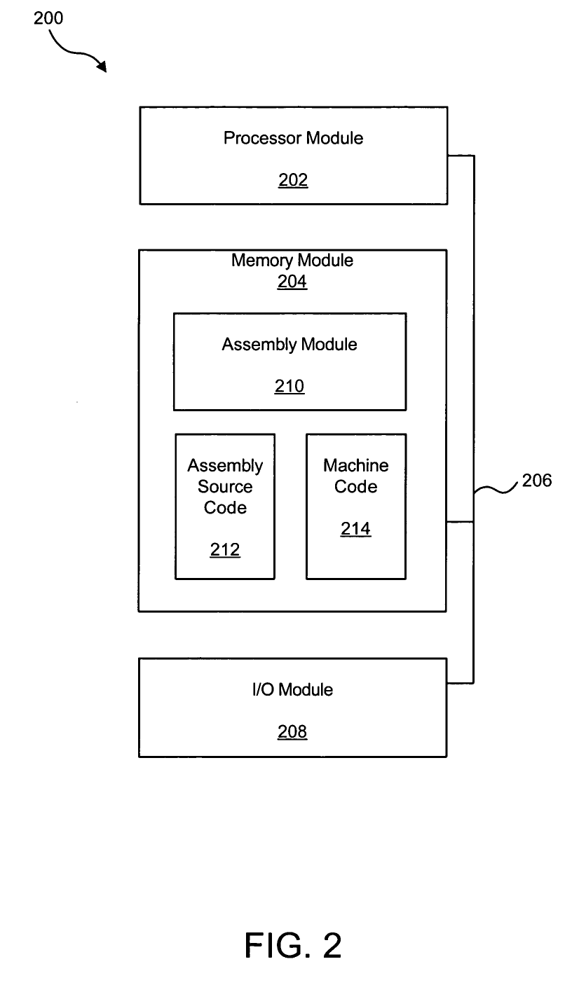

FIG. 2 illustrates a system 200 for identifying semantic errors in assembly source code. A processor module 202 executes instructions known as machine code. The processor module 202 retrieves the instructions from a memory module 204 using a bus 206. Input and output related to the execution of the instructions by the processor module 202 are provided to a user by an I/O module 208. The I/O module 208 typically comprises a monitor and keyboard. The I/O module 208 could also include a printer, audio system, disk and tape drives, and the like.

The memory module 204 stores an assembly module 210, assembly source code 212, and machine code 214 in silicon memory devices, magnetic hard drives, or other volatile or non-volatile storage devices. The memory module 204 provides stored data to the processor module 202 by communicating with the processor module 202 via the bus 206.

The assembly module 210 comprises a set of machine code that may be executed by the processor module 202. The assembly module 210 identifies semantic errors in the assembly source code 212. Preferably the assembly module 210 also converts the assembly source code 212 into machine code 214. The assembly module 210 may be an independent module or may be integrated with a conventional assembly language assembler.

The bus 206 is a general-purpose device for communication between the coo memory module 204, processor module 202, and I/O module 208. The bus 206 can be a short distance bus, where each of the modules 202,204,208 are located in the same chassis, or can be a bus 206 that enables the modules 202,204,208 to be distributed. The bus 206 may comprise various media including: wired, wireless, copper, fiber optics, and the like.

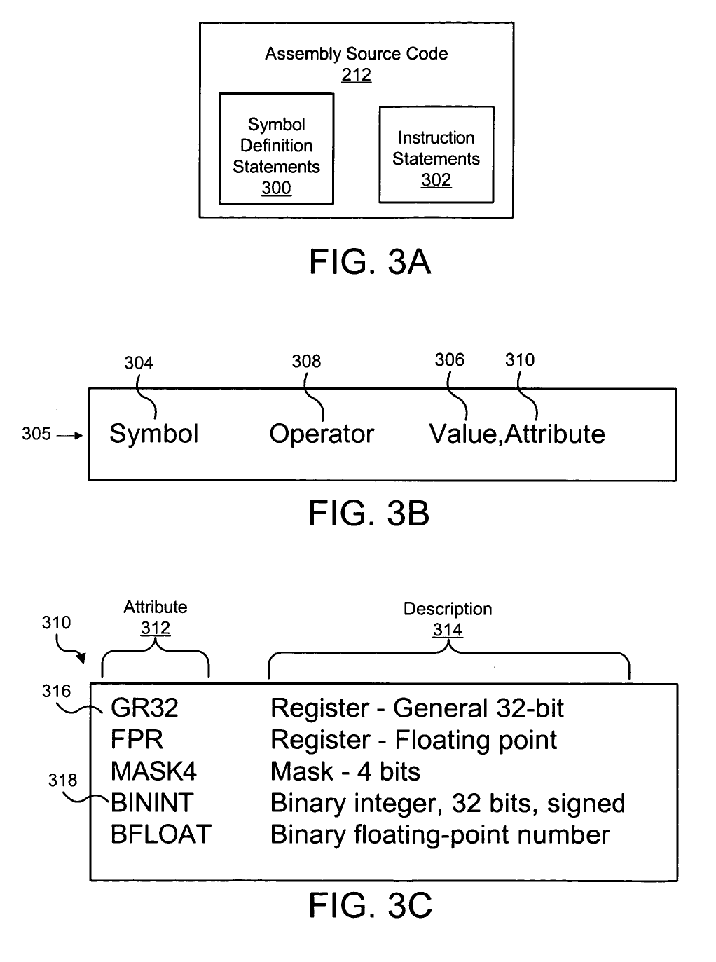

FIG. 3A illustrates further details of the assembly source code 212. The assembly source code 212 comprises two types of instructions: symbol definition statements 300 that define symbols and instruction statements 302 that provide specific commands that the processor module 202 executes.

A programmer writes symbol definition statements 300 in the assembly source code 212 using the syntax illustrated in FIG. 3B. A symbol 304 in the symbol definition statement 305 is a character or character string the programmer creates that provides a flexible, meaningful name for use in writing instruction statements 302. The programmer specifies a value 306 to be assigned to the symbol 304 and also specifies an operator 308 that assigns the value 306 to the symbol 304.

Preferably the programmer creates a plurality of symbols, and each symbol 304 may have the same or different value 306. This enables intuitive, understandable code since the programmer may use symbols 304 with meaningful names as operands rather than numbers. Using symbols 304 widely in assembly source code 212 facilitates readability and understanding of assembly source code 212 by more than one programmer since the assembly source code 212 is typically more logical and intuitive if symbols 304 are used.

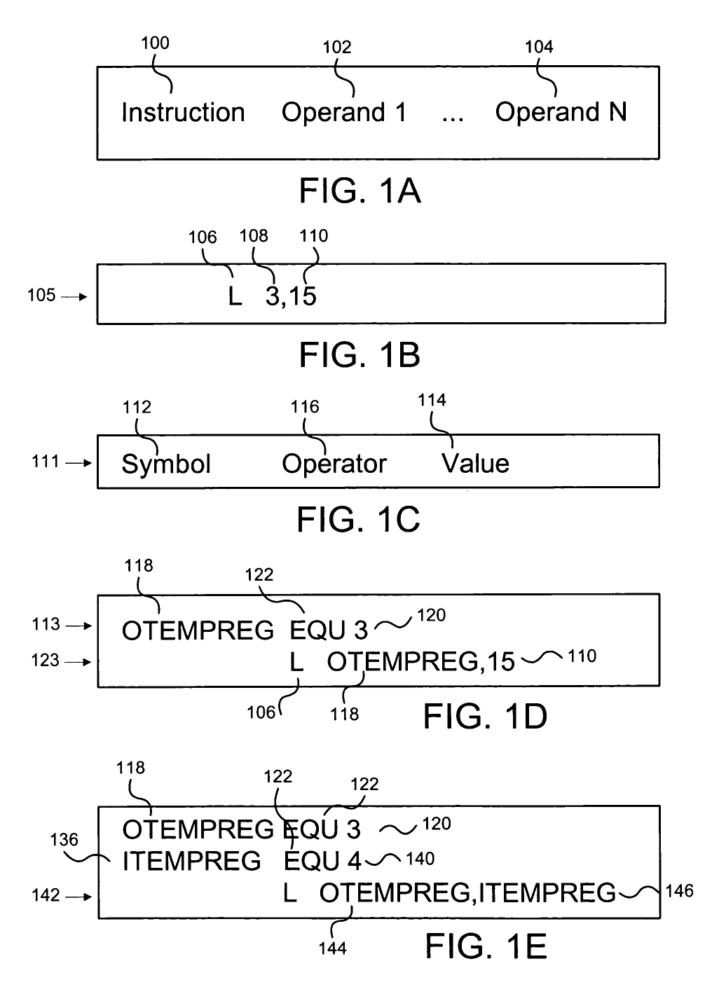

In a certain embodiment, the programmer assigns an attribute 310 to the symbol 304. The addition of the attribute 310 to the symbol definition statement 305 enables the assembly module 210 to find semantic errors in assembly source code 212. The assembly module 210 locates errors by using the attribute 310 to find symbols 304 in the assembly source code 212 that are used improperly as operands 102,104 in an instruction statement 302. As illustrated in FIG. 1C, an attribute 310 is not a part of conventional symbol definition statements 111. Each symbol definition statement 305 may include a single attribute 310. The attribute 310 may comprise either a predefined attribute or a programmer-defined attribute. In certain embodiments, a symbol definition statement 305 may include a plurality of attributes 310.

The assembly module 210 preferably defines a set of predefined attributes. The programmer may select an attribute 310 from this list of predefined attributes when writing assembly source code 212. Since this list of predefined attributes may not address all the needs of the programmer, the programmer may define an attribute 310 referred to as a programmer-defined attribute.

Consequently, a programmer may assign multiple attributes 310, such as a predefined attribute and a programmer-defined attribute to a symbol 304. Assigning multiple attributes 310 may allow a programmer to perform additional type checking of symbols 304 in relation to certain operands for assembly code instruction statements 302. Alternatively, the programmer may narrow the range of valid values 306 that would otherwise satisfy an existing predefined attribute. For example, if a symbol is defined for use as a day in a month the value of the symbol should be an integer between one and thirty-one (since there are no more than thirty-one days in a month). To implement this functionality a predefined attribute for integers could be used in conjunction with a programmer-defined attribute that verifies that the value 306 is between one and thirty-one.

FIG. 3C illustrates a chart 310 of sample predefined attributes. Five example attributes 312 are listed along with a brief description 314 of the type of data associated with that attribute 312. The GR32 attribute 316 indicates that the value 306 is a general register holding 32-bit data. Other attributes 312 may define a type format for the value 306. The BINIT attribute 318 indicates that the value 306 is data in a binary integer format.

In addition to symbol definition statements 305, the programmer writes instruction statements 302 using the syntax of the template shown in FIG. 1A. The programmer selects an instruction 100 from a set of predefined instructions that the assembly module 210 is programmed to understand.

The instruction 100 is specified and one or more operands 102,104 for the instruction 100 are specified. The operands 102,104 are inputs, or arguments, to the instruction 100. For example an instruction that adds two numbers together requires two operands, which are the locations of the two numbers that are to be added together.

The number of operands 102,104 required by an instruction 100 varies per instruction 100. Each instruction 100 expects the operands 102,104 to be in a specific format and/or of a certain type in order to be valid. Certain operands 102,104 may have a limited range of valid data values. For example, some operands 102,104 specify a register number. If the range of valid register numbers for a particular processor module 202 is zero to fifteen, then an operand 102 that specifies a register number of eighteen is not a valid operand 102 for the instruction 100. These restrictions on format, type, and potentially value range comprise semantic requirements for the operands 102,104. Failure to satisfy the semantic requirements for operands 102,104 when writing assembly source code 212 comprises a semantic error.

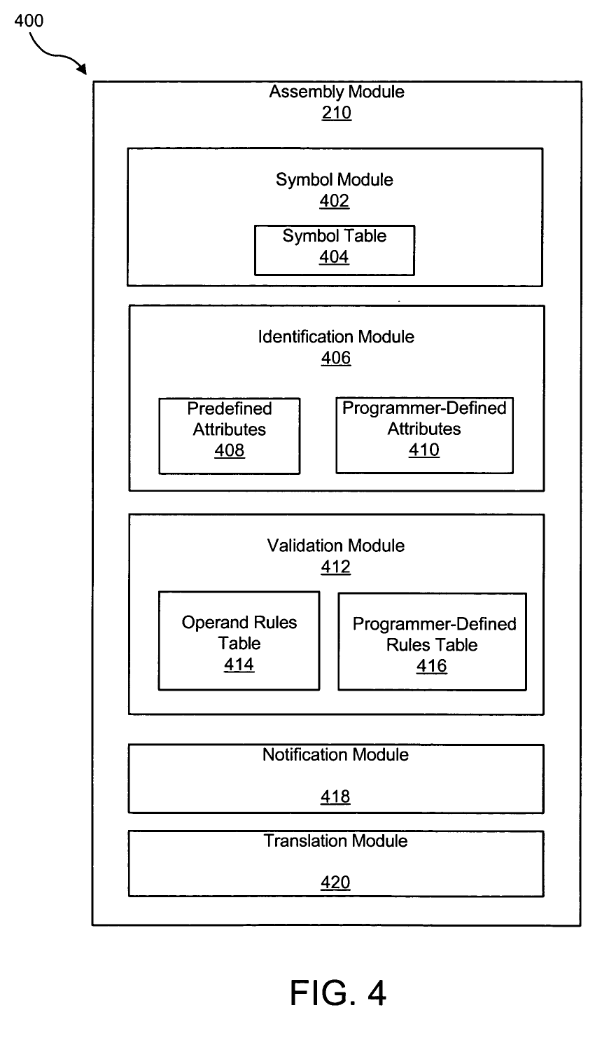

FIG. 4 illustrates one embodiment of an apparatus 400 for identifying semantic errors in assembly source code 212. The apparatus 400 may comprise the assembly module 210 described in relation to FIG. 2. The assembly module 210 includes a symbol module 402 that searches assembly source code 212 for a symbol definition statement 305 (See FIGS. 3A-C) and stores information about the symbol 304 in a symbol table 404.

An identification module 406 recognizes an attribute 310 (See FIG. 3C) assigned to a symbol 304 found by the symbol module 402. The identification module 406 identifies the attribute 310 as either a predefined attribute 408 or a programmer-defined attribute 410.

A validation module 412 reads each of the instruction statements 302 in the assembly source code 212. The validation module 412 finds instruction statements 302 that use the symbol 304 as one of the operands 102,104. The validation module 412 then validates the attribute 310 associated with the symbol 304.

Predefined attributes 408 may be validated using an operand rules table 414. Programmer-defined attributes 410 may be validated using a programmer-defined rules table 416. If the validation module 412 determines the symbol 304 provided as an operand 102 for the instruction 100 is invalid, based on comparing the attribute 310 of the symbol 304 with the operand rules 414,416, then a semantic error has been identified.

In response to finding a semantic error, the notification module 418 may notify the I/O module 208 of the error and the I/O module 208 warns the user. If no semantic errors are identified, a translation module 420 may translate the assembly source code 212 into machine code 214. Alternatively, semantic errors may be reported to a user while the translation module 420 still translates the assembly source code 212.

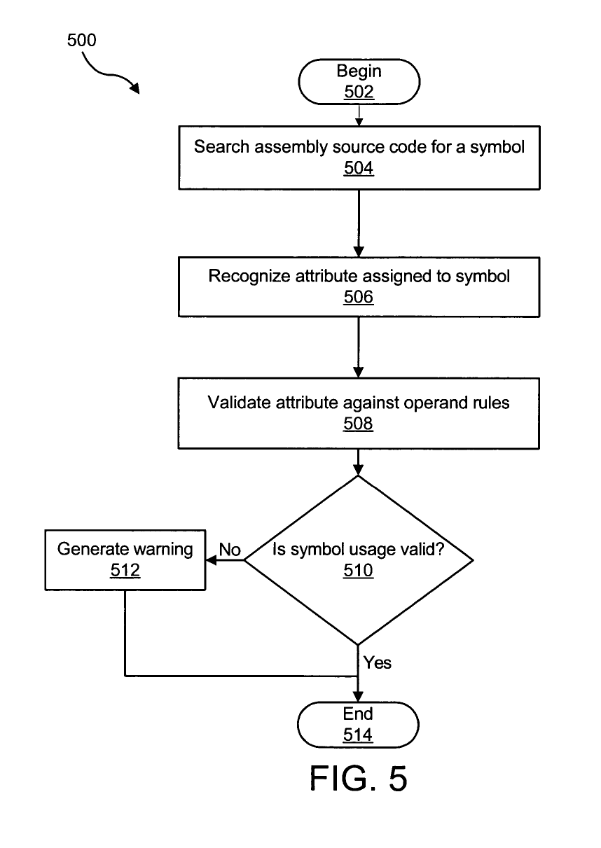

FIG. 5 illustrates one embodiment of a method 500 for identifying semantic errors in assembly source code 212. The method 500 begins 502 when the symbol module 402 (see FIG. 4) searches 504 assembly source code 212 for a symbol 304 (see FIG. 3B). The symbol module 402 preferably inspects each line of the assembly source code 212. Lines that comprise symbol definition statements 300 are identified. The symbol module 402 extracts the symbol name 304 and value 306 from the identified symbol definition statements 300 and stores them in the symbol table 404. In one embodiment, the symbol module 402 extracts the attribute 310 from the symbol definition statement and stores the attribute 310 in the symbol table 404 with the associated symbol name 304 and value 306.

The identification module 406 also inspects the lines of the assembly source code 212 that the symbol module 402 identifies as symbol definition statements 300. The identification module 406 recognizes 506 an attribute 310 assigned to a symbol 304 by comparing the attribute 310 with a list of predefined attributes 408 such as the examples set forth in FIG. 3C. The attribute 310 defines the type of value 306 that has been assigned to the symbol 304. The identification module 406 may reference the symbol table 404 or the assembly source code 212 directly to identify the attribute 310.

Predefined attributes 408 may comprise a predefined list available to the assembly module 210. The programmer selects an attribute 310 from this list when writing a symbol definition statement 305. The programmer references this list in a manual or help file. Typically, a programmer cannot modify the list of predefined attributes 408.

If the attribute 310 is on the list of predefined attributes 408 the identification module 406 associates the attribute 310 with the symbol 304. In one embodiment, the symbol 304 and attribute 310 are associated by adding the attribute 310 to the symbol table 404. If the attribute 310 is not on the list of predefined attributes 408 the notification module 418 may inform the user via the I/O module 208.

Next, the validation module 412 may inspect the lines of the assembly source code 212 that use the symbol 304 as an operand 102 for an instruction 100 (See FIG. 1A). The validation module 412 validates 508 that the symbol 304 is an acceptable operand 102 for the particular instruction 100 by checking the attribute 310 against the operand rules in the operand rules table 414.

If the validation module 412 determines 510 that the symbol 304 is not a valid operand 102 for the instruction 100, the notification module 418 may generate 512 a warning message that informs the user via the I/O module 208, and the method ends 514. The programmer can choose to then modify the assembly source code 212 to correct the semantic error or ignore the error. If the validation module 412 determines 510 that the symbol 304 is a valid operand 102 for the instruction 100, the method ends 514. Typically, the method 500 then repeats for each instruction 100 in the assembly code having symbols for operands.

In one embodiment, the validation module 412 uses the operand rules table 414 to validate the attribute 310 of the symbol 304. Each assembly instruction 100 preferably has an entry in the operand rules table 414. Each instruction entry defines the number of required operands for the instruction 100. The operand rules table 414 preferably contains a list of acceptable attributes for each operand 102,104 of each instruction 100.

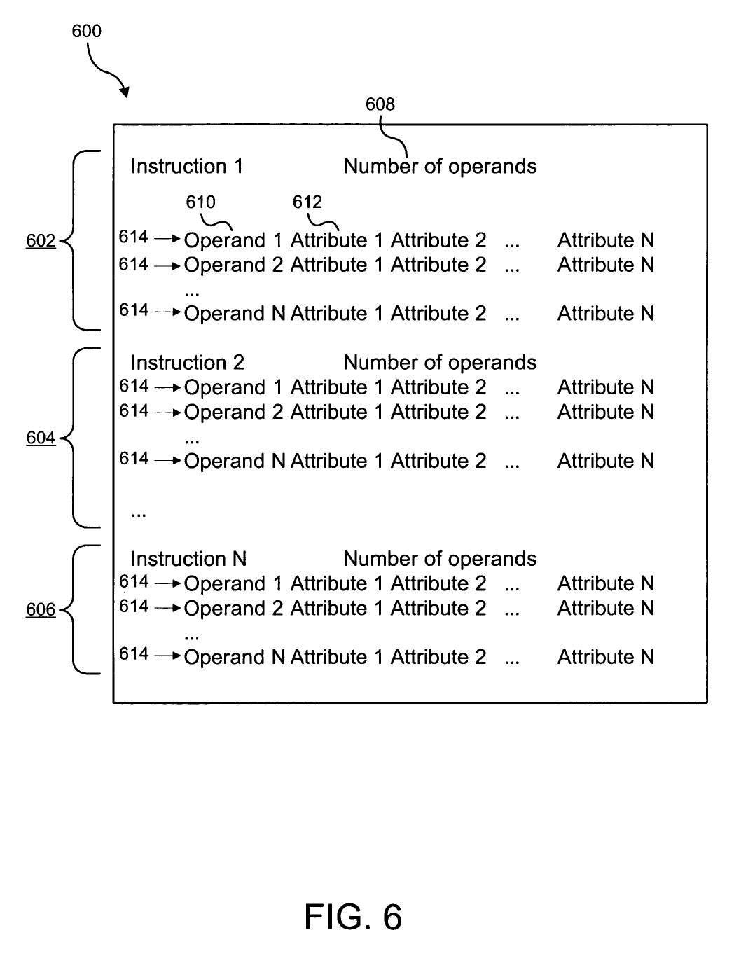

FIG. 6 illustrates one embodiment of a structure 600 for storing and defining an operand rules table 414. Of course various structures 600 may be used. The structure includes instruction entries for instructions 602,604,606 one through N. Each of these instruction entries 602,604,606 includes the number of operands 608 required by the instruction 602, and a list of operands 610 for the instruction 602. A set of indented rows for each instruction 602 includes a list of one or more acceptable attributes 612 for each operand 610. The attributes 612 may comprise predefined attributes 408, programmer-defined attributes 410, or a combination of both. Each indented row of the structure 600 comprises an operand rule 614.

In order to validate that a symbol 304 is acceptable for use as an operand 102,104 in an instruction statement 302, the validation module 412 may look up the attribute 310 associated with the symbol 304 in the symbol table 404. The validation module 412 determines the list of acceptable attributes 612 for the operand 610 by looking up the instruction 602 and the instruction's operand 610 in the operand rules table 600 to find the appropriate operand rule 614.

If the attribute 310 matches one of the acceptable operand attributes 612 listed in the operand rules table 600 for the operand in which the symbol is being used, the symbol 304 is valid for use in that particular operand 102 for the instruction 602. If the symbol attribute 310 is not one of the acceptable operand attributes 612, the symbol 304 is not valid for use as an operand 102 for the instruction 602. The programmer has violated the specified semantic requirements for an instruction 602 by using the symbol 304.

The assembly module 210 provides acceptable attributes 612 for each operand 610 of each instruction 602,604,606 in the operand rules table 600. The attributes 612 may be different for each operand 610 of each instruction 602,604,606. The attributes assigned by the assembly module for a particular instruction 602,604,606 comprise default operand rules 614 for the instruction 602,604,606. The assembly module 210 specifies default operand rules that are logical and useful to a programmer. In some embodiments, the programmer may modify the default rules for an instruction 602,604,606 by changing the attributes 612 associated with each operand 610 of the instruction 602,604,606 in the operand rules table 600.

For example, if the programmer did not want to allow 4-bit values anywhere in the assembly source code the default values of the operand rules table 600 could be edited so that all 4-bit attributes are removed from the table 600. Then, if assembly source code 212 inadvertently includes symbols 304 with 4-bit attributes, these symbols 304 will be detected and warnings generated. Validating that a symbol 304 is acceptable for use as an operand 102, as described above, is a powerful way of identifying semantic errors in assembly source code 212.

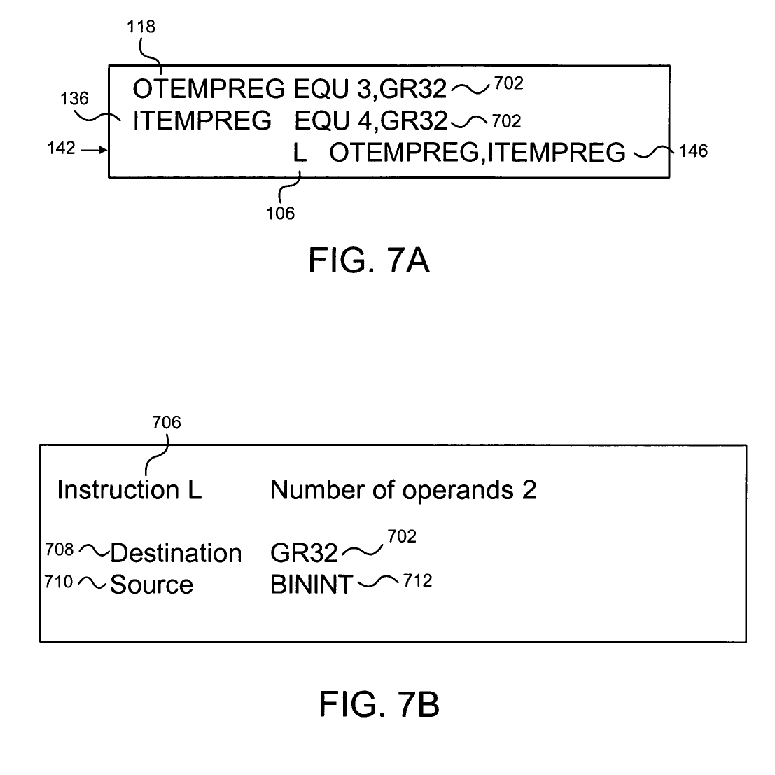

FIGS. 7A-B illustrate the use of symbols 304 with attributes 310 to identify the assembly source code semantic error illustrated in FIGS. 1A-E. By way of example, a GR32 register address attribute 702 is assigned to the OTEMPREG symbol 1118 when the symbol 118 is defined. In FIG. 7B, the operand rules table entry for the “L” instruction 706 lists two operands, a destination 708 and a source 710. The acceptable operand attribute for the first operand 708 is a GR32 register address attribute 702. The acceptable operand attribute for the second operand 710 does not include a register address attribute 702 since this operand 710 is a storage address, not a register address. Instead, the acceptable operand attribute for the second operand 710 includes a storage address operand such as BININT 712.

The ITEMPREG symbol 136 is defined with a GR32 register address attribute 702 since it is meant to refer to a register number. When the validation module 412 checks the set of symbol definition statements 300 and the instruction statements 302, the validation module 412 generates an error warning.

The validation module 412 generates the error warning since the instruction statement 142 attempts to use a symbol 136 with a register address attribute GR32 for the second operand 146 of the “L” instruction. The operand rules table entry 706 for the “L” instruction does not permit this association. The detection of this subtle semantic error can save significant time since further debugging is not required.

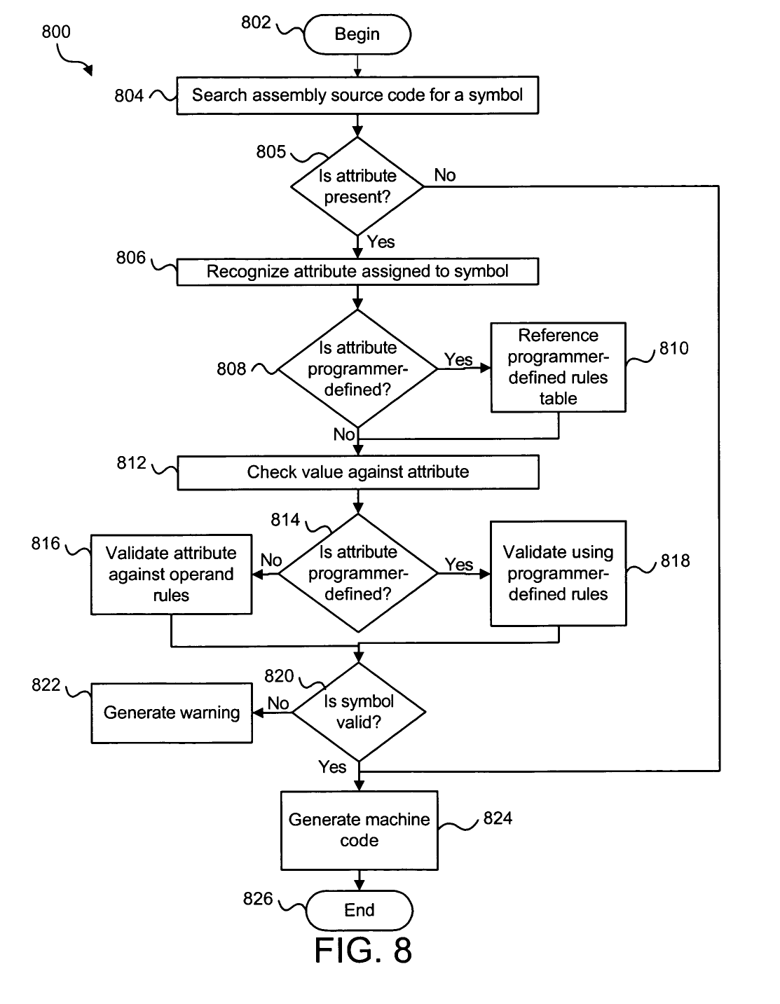

FIG. 8 illustrates an alternate embodiment of a method 800 for identifying semantic errors in assembly source code 212. The method starts 802 when the symbol module 402 searches 804 assembly source code 212 for a symbol 304 as previously described. If the symbol module 402 determines 805 that there are no symbols 304 in the assembly source code 212 the method ends 826. If symbols 304 are present in the assemble source code 212 the method continues.

The identification module 406 recognizes 806 an attribute 310 assigned to the symbol 304 as described above. However, in this embodiment, the programmer designates the attribute 310 as either a predefined attribute 408 or a programmer-defined attribute 410.

Programmer-defined attributes 410 allow customized attribute behavior. The custom attribute behavior may be defined in a set of code associated with the programmer-defined attribute 410. The set of code comprises programmer-defined rules that may be stored in a programmer-defined rules table 416 of the validation module 412.

If the identification module 406 determines 808 that the attribute 310 is a programmer-defined attribute 408, the programmer-defined rules table 416 is referenced 810 to ensure that programmer-defined rules exist for the programmer-defined attribute 408. If no programmer-defined rules exist, the notification module 418 may inform the user via the I/O module 208.

Next, the validation module 412 checks 812 the symbol definition statement 305 to ensure that the value 306 specified for the symbol 304 is consistent with the attribute 310 specified for the symbol 304. For example, if the value 306 is a floating-point number and the attribute 310 specifies that the symbol 304 should be an integer the value 306 and the attribute 310 are inconsistent. If the value 306 and attribute 310 are inconsistent, the notification module 418 may inform the user via the I/O module 208.

The validation module 412 inspects the lines of the assembly source code 212 that use the symbol 304 as an operand 102,104 of an instruction 100. The validation module 412 validates that the symbol 304 is an acceptable operand 102,104 for the instruction 100. The validation module 412 determines 814 whether the attribute 310 for an instruction 100 using a symbol 304 is programmer-defined. If the attribute 310 is not a programmer-defined attribute 410 the validation 816 occurs using the operand rules table 414 as discussed above in relation to FIG. 5.

If the attribute 310 is a programmer-defined attribute 410, the validation con module 412 validates 818 the programmer-defined attribute 410 by executing the programmer-defined rule code associated with the programmer-defined attribute 410 in the programmer-defined rules table 416. Typically, the programmer-defined rule code performs certain condition checks on the value 306 associated with the symbol 304. Executing the set of code associated with the programmer-defined attribute 410 stored in the programmer-defined rules table 416 returns either a valid or invalid result.

If the validation module 412 determines 820 that the symbol 304 is not a valid operand 102,104 for the instruction 100 the notification module 418 may inform 822 the user via the I/O module 208. The programmer can choose to modify the source assembly code 212 so that a valid operand 102,104 is used, or may ignore the semantic error.

In one embodiment, translation of assembly source code 212 may stop once a semantic error is detected. If no invalid symbols 304 are found, the translation module 420 may generate 824 machine code 214 from the assembly source code 212, and the method ends 826. The translation module 420 uses the symbol table 404 to substitute the symbol value 306 for the symbol 304 when a symbol 304 is used as an operand 102,104. The translation module 420 then converts the symbol-less instruction statements into corresponding machine code 214. Consequently, translation of the assembly source code 212 may be completed with two passes through the assembly source code 212.

The embodiments of the present invention may be embodied in other specific forms without departing from its spirit or essential characteristics. The described embodiments are to be considered in all respects only as illustrative and not restrictive. The scope of different embodiments of the invention is, therefore, indicated by the appended claims rather than by the foregoing description. All changes which come within the meaning and range of equivalency of the claims are to be embraced within their scope.

1. A apparatus for identifying semantic errors in assembly source code, the apparatus comprising:
a symbol module configured to search assembly source code for a symbol definition
an identification module configured to recognize an attribute assigned to a symbol;
a validation module configured to validate the attribute of the symbol against operand rules for an instruction in the assembly source code; and
a notification module configured to generate warnings in response to the symbol violating the operand rules for the instruction.

2. The apparatus of claim 1 wherein the symbol is programmer-defined.

3. The apparatus of claim 1 wherein the validation module is further configured to modify the operand rules by editing a list of acceptable attributes associated with each operand of each instruction.

4. The apparatus of claim 1 wherein the operand rules comprise default rules for each operand of each instruction.

5. The apparatus of claim 1 wherein the attribute is selected from a list of predefined attributes.

6. The apparatus of claim 1 wherein the attribute is a programmer-defined attribute.

7. The apparatus of claim 6 wherein the validation module is further configured to associate programmer-defined operand rules with each programmer-defined attribute.

8. The apparatus of claim 7 wherein the validation module is further configured to validate the programmer-defined attribute of the symbol against programmer-defined operand rules for the instruction.

9. The apparatus of claim 1 wherein the symbol module is further configured to verify that a value assigned to the symbol satisfies the attribute;

10. The apparatus of claim 1 further comprising a translation module configured to translate instructions with valid operands into machine code.

11. A system for identifying semantic errors in assembly source code, the system comprising:
a processor module configured to execute machine code;
an Input/Output (I/O) module configured to notify the user of semantic errors in assembly source code;
a memory module configured to store and retrieve data comprising an assembly module including,
a symbol module configured to search assembly source code for a symbol definition
an identification module configured to recognize an attribute assigned to a symbol;
a validation module configured to validate the attribute of the symbol against operand rules for an instruction in the assembly source code;
a notification module configured to generate warnings in response to the symbol violating the operand rules for the instruction; and
a bus configured to enable communication between the memory module, processor module, and I/O module.

12. The system of claim 11 wherein the symbol is programmer-defined.

13. The system of claim 11 wherein the validation module is further configured to modify the operand rules by editing a list of acceptable attributes associated with each operand of each instruction.

14. The system of claim 11 wherein the operand rules comprise default rules for each operand of each instruction.

15. The system of claim 11 wherein the attribute is selected from a list of predefined attributes.

16. The system of claim 11 wherein the attribute is a programmer-defined attribute.

17. The system of claim 16 wherein the validation module is further configured to associate programmer-defined operand rules with each programmer-defined attribute.

18. The system of claim 17 wherein the validation module is further configured to validate the programmer-defined attribute of the symbol against programmer-defined operand rules for the instruction.

19. The system of claim 11 wherein the symbol module is further configured to verify that a value assigned to the symbol satisfies the attribute;

20. The system of claim 11 wherein the assembly module further comprises a translation module configured to translate instructions with valid operands into machine code.

21. A signal bearing medium tangibly embodying a program of machine-readable instructions executable by a digital processing apparatus to perform operations to find semantic errors in assembly source code, the operations comprising:
an operation to search assembly source code for a symbol definition;
an operation to recognize an attribute assigned to a symbol;
an operation to validate the attribute of the symbol against operand rules for an instruction in the assembly source code; and
an operation to generate warnings in response to the symbol violating the operand rules for the instruction.

22. The signal bearing medium of claim 21 wherein the symbol is programmer-defined.

23. The signal bearing medium of claim 21 further comprising an operation to modify the operand rules by editing a list of acceptable attributes associated with each operand of each instruction.

24. The signal bearing medium of claim 21 wherein the operand rules comprise default rules for each operand of each instruction.

25. The signal bearing medium of claim 21 wherein the attribute is selected from a list of predefined attributes.

26. The signal bearing medium of claim 21 wherein the attribute is a programmer-defined attribute.

27. The signal bearing medium of claim 26 further comprising an operation to associate programmer-defined operand rules with each programmer-defined attribute.

28. The signal bearing medium of claim 27 further comprising an operation to validate the programmer-defined attribute of the symbol against programmer-defined operand rules for the instruction.

29. The signal bearing medium of claim 21 further comprising an operation to verify that a value assigned to the symbol satisfies the attribute;

30. The signal bearing medium of claim 21 further comprising an operation to translate instructions with valid operands into machine code.
